(19) United States
(12) Patent Application Publication
(10) Pub. No.: US 2010/0142888 A1
(43) Pub. Date: Jun. 10, 2010

(54) COMPACT FIBER DISTRIBUTION HUB

(75) Inventors: Ludwig C. Graff, Ellicott City, MD (US); Vijay Jain, West Friendship, MD (US)

Correspondence Address: VERIZON;PATENT MANAGEMENT GROUP, 1320 North Court House Road, 9th Floor, ARLINGTON, VA, 22201-2909, US

(73) Assignee: VERIZON CORPORATE RESOURCES GROUP LLC, Basking Ridge, NJ (US)

(21) Appl. No.: 12/331,783

(22) Filed: Dec. 10, 2008

(51) Int. Cl. G02B 6/36; G02B 6/28

(52) U.S. Cl. 385/24; 385/135

(57) ABSTRACT

A device may provide a first opening via which a feeder optical fiber cable that carries an input signal enters the device. In addition, the device may include a slot configured to retain a splitter module. The splitter module may include a single-fiber input cable that receives and carries the input signal from the feeder optical fiber cable, an optical splitter that receives the input signal from the single-fiber input cable, splits the input signal into a plurality of output signals, and transmits each of the plurality of output signals, and a multi-fiber output cable that receives the plurality of output signals from the optical splitter and carries the plurality of output signals. The device may also provide a second opening via which a multi-fiber distribution cable that receives the plurality of output signals from the multi-fiber output cable exits the device. The multi-fiber distribution cable may carry the plurality of output signals.

### BACKGROUND INFORMATION

Fiber distribution hubs may be installed inside a building to provide dwellers within the building with optical fiber lines. A fiber distribution hub may include a splitter module that splits an optical beam from an optical fiber (e.g., a fiber in a feeder cable from a service provider) into multiple optical beams, and outputs the split beams to multiple optical fibers. The multiple optical fibers are typically connected to cables that provide service (e.g., cable television programs, video-on-demand, etc.) to customers.

### BRIEF DESCRIPTION OF THE DRAWINGS

FIG. 1 illustrates an exemplary optical network in which concepts described herein may be implemented;

FIG. 2 is a block diagram of a portion of an exemplary multiple dwelling unit complex;

FIG. 3 is a functional block diagram of a fiber distribution hub of FIG. 2;

FIG. 4 illustrates the fiber distribution hub of FIG. 3 according to one exemplary implementation;

FIG. 5A illustrates an exemplary implementation of a splitter module of FIG. 4;

FIG. 5B is a diagram illustrating exemplary contents of a splitter container of FIG. 5A;

FIG. 6 illustrates another exemplary implementation of the splitter module of FIG. 4;

FIG. 7A is a diagram of an adaptor of FIG. 4 according to an exemplary implementation;

FIG. 7B illustrates operation of the adaptor of FIG. 7A; and

FIG. 8 is a flow diagram of an exemplary process that is associated with operation of the fiber distribution hub of FIG. 4.

### DETAILED DESCRIPTION OF PREFERRED EMBODIMENTS

The following detailed description refers to the accompanying drawings. The same reference numbers in different drawings may identify the same or similar elements.

As described below, a compact fiber distribution hub may be attached to multi-fiber distribution cables. In such an implementation, a single run of multi-fiber distribution cable may service a number of premises (e.g., living units). In contrast, where a fiber distribution hub is attached to single-fiber distribution cables, multiple runs of single fiber distribution cable may be required to service the same number of premises. Thus, the compact fiber distribution hub may provide for savings in cost associated with cabling (e.g., 30% savings).

In one implementation, a compact fiber distribution hub may include splitter modules that exclude fiber loop slack. Such a compact fiber distribution hub may be much smaller than ones that include splitter modules with fiber loop slack. Consequently, the compact fiber distribution hubs may be easier to install and configure.

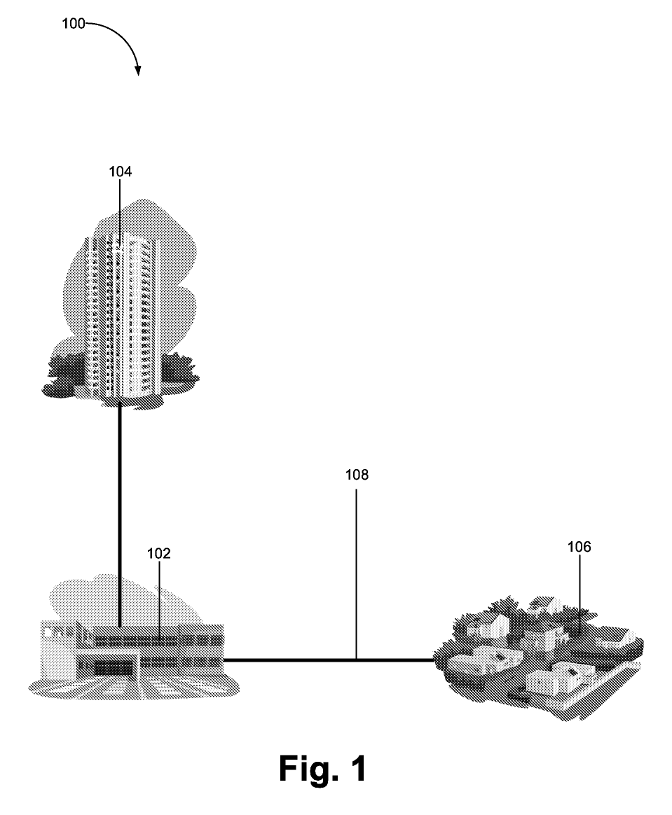

FIG. 1 shows an exemplary optical network 100 in which the concepts described herein may be implemented. As shown, optical network 100, which may be referred to as a fiber-to-the-premises (FTTP) network, may include a central office 102, a multiple dwelling unit complex 104, a single dwelling unit complex 106, and feeder optical fiber cables 108. An actual optical network may include may include additional, fewer, or different dwelling complexes and components than optical network 100.

Central office 102 may include a site that houses telecommunication equipment, including switches, optical line terminals, etc. Central office 102 may provide telecommunication services to subscribers, such as telephone service, access to the Internet, cable television programs, etc., via optical line terminals.

Multiple dwelling unit complex 104 may include apartments, condominiums, and/or other types of living units that are aggregated in a high-rise or another type of building. Single dwelling unit complex 106 may include attached town houses, single detached houses, condominiums, and/or other types of horizontally aggregated living units.

Feeder optical fiber cables 108 may include optical fiber cable bundles that interconnect multiple dwelling unit complex 104 and/or single dwelling unit complex 106 to optical line terminals in central office 102.

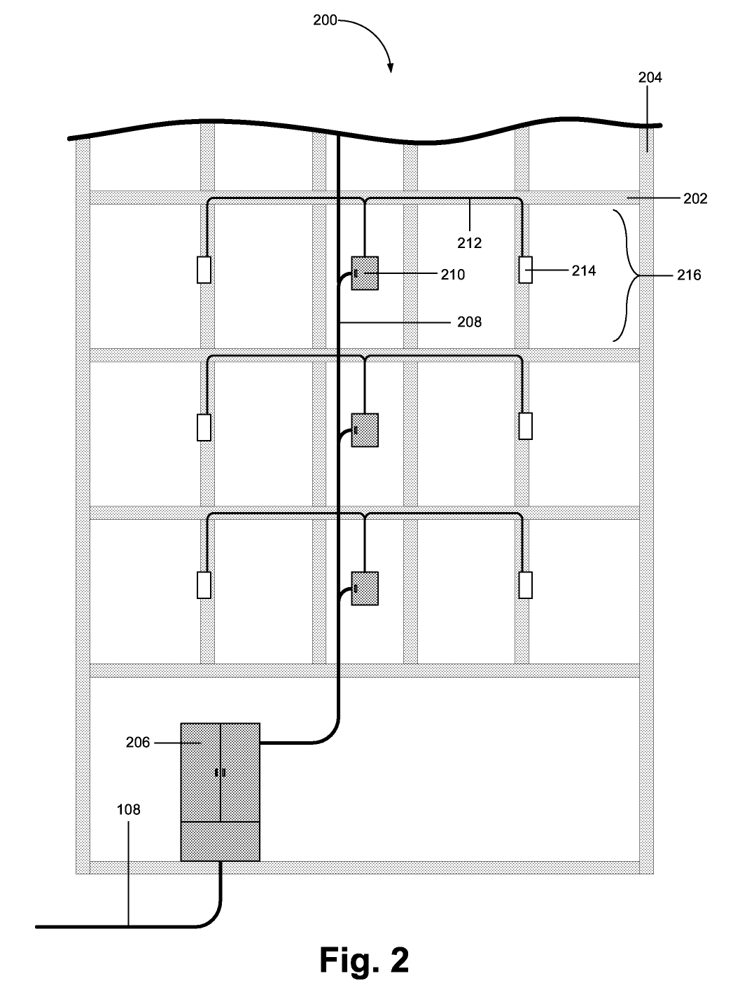

FIG. 2 is a diagram of a portion of an exemplary multiple dwelling unit complex 104. As shown, multiple dwelling unit complex 104 may include a floor/ceiling 202, a wall 204, a fiber distribution hub 206, a distribution cable bundle 208, a fiber distribution terminal 210, a drop cable 212, a optical network terminal 214, and a living unit 216. In FIG. 2, some components of multiple dwelling unit complex 104 are omitted for the sake of simplicity in illustration (e.g., stairs, doors, elevators, etc.). In addition, depending on the implementation, multiple dwelling unit complex 104 may include additional, fewer, or different components than those illustrated in FIG. 2. For example, in some implementations, fiber distribution terminal 210 may be connected to fiber distribution hub 206 through another component, such as a collector box that receives ribbon fiber cables, and provides the ribbon cables connectivity to fiber distribution terminals.

Ceiling/floor 202 and wall 204 may partition space within multiple dwelling unit complex 104 into multiple living units. Fiber distribution hub 206 may include an enclosure (e.g., a plastic or metal cabinet) to receive feeder optical fiber cables 108, split an optical signal on an optical fiber within optical fiber cables 108 into multiple optical signals, convey the split optical signals to fiber distribution cables, collect the fiber distribution cables into distribution cable bundle 208, and provide distribution cable bundle 208.

Distribution cable bundle 208 may include fiber distribution cables that carry optical fibers from fiber distribution hub 206 to fiber distribution terminal 210. In some implementations, distribution cable bundle 208 may be tapered as it is routed vertically through multiple dwelling unit complex 104 and as fiber distribution cables are branched from distribution cable bundle 208 to feed one or more of fiber distribution terminal 210. Fiber distribution terminal 210, which is also referred to as fiber access terminal 210, may include an enclosure to receive a fiber distribution cable from distribution cable bundle 208.

Drop cable 212 may include an optical fiber that carries an optical signal from a fiber distribution cable in fiber distribution terminal 210 to optical network terminal 214. Typically, drop cable 212 may be installed in a raceway that is placed along the ceiling of a hallway, in a conduit, in a duct, etc.

Optical network terminal 214, which may also be called optical network unit 214, may receive optical signals via drop cable 212 and convert the received optical signals into electrical signals that are further processed or carried over, for example, copper wires to one or more living units. In some implementations, optical network terminal 214 may be placed within a living unit, and devices that use services offered by central office 102 may be directly connected to optical network terminal 214.

Living unit 216 may include a partitioned space that a tenant or an owner of the living unit 216 may occupy. Living unit 216 may house devices that are attached directly or indirectly, via copper wires, to optical network terminal 214 to receive services that central office 102 provides.

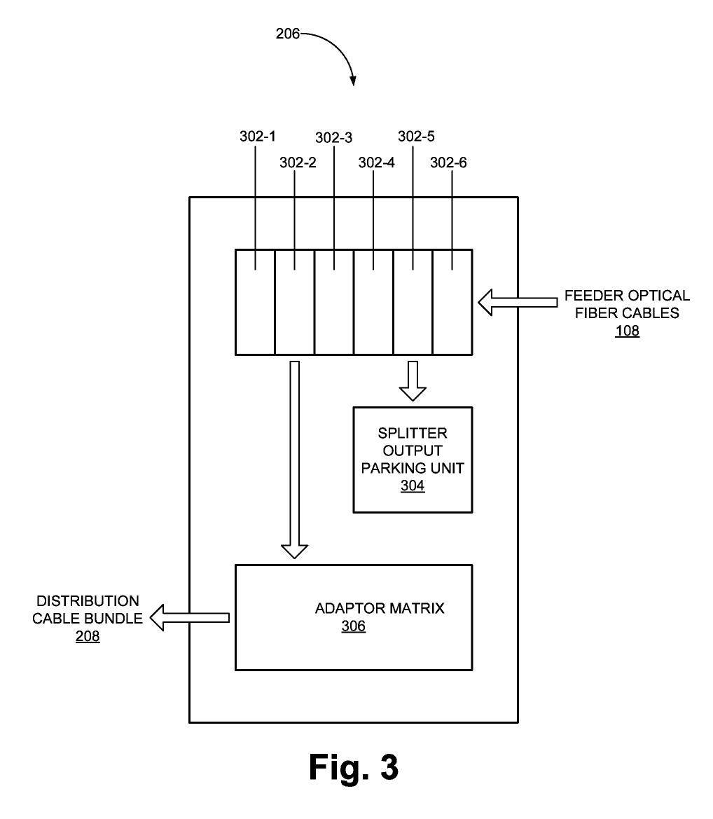

FIG. 3 is a functional block diagram of fiber distribution hub 206. As shown, fiber distribution hub 206 may include splitter modules 302-1 through 302-6 (herein individually and collectively referred to as splitter modules 302 and splitter module 302, respectively), a splitter output parking unit 304, and a adaptor matrix 306. Depending on the implementation, fiber distribution hub 206 may include additional, fewer, or different functional components than those illustrated in FIG. 3. For example, in some implementations, fiber distribution hub 206 may include additional splitter modules (e.g., 13 additional splitter modules), and/or may not include splitter output parking unit 304.

Splitter module 302 may include an assembly of an optical splitter and optical fiber cables. Splitter module 302 may receive an optical signal over an input cable, split the beam into multiple optical signals, and transmit the multiple optical signals to output cables that are connected to the optical splitter.

In FIG. 3, an input cable of splitter module 302 may be attached to a fiber cable from feeder optical fiber cables 108. In one implementation, feeder optical fiber cables 108 may enter fiber distribution hub 206 from the bottom or lower portion, be routed through fiber distribution hub 206, and provide an optical fiber cable that is mated to an input cable of splitter module 302 via connectors and an adaptor.

Splitter output parking unit 304 may include slots in which ribbon cables from splitter modules 302 may be parked until the ribbon cables are attached to fiber distribution cables to provide signal pathways to living units 216 in multiple dwelling unit complex 104.

Adaptor matrix 306 may include a mechanism (e.g., fiber optic patch panel) to hold adaptors via which connectors at ends of output cables from splitter modules 302 and connectors at ends of fiber distribution cables are adjoined. In some implementations, the components may include adaptors (e.g., plugs, etc.) or the like, that join multi-fiber connectors (e.g., mechanical transfer-angle polished connector (MT-APC)).

Although not illustrated in FIG. 3, fiber distribution hub 206 may be housed in a metal or plastic enclosure. The metal or the plastic enclosure may be Underwriters Laboratory (UL) listed.

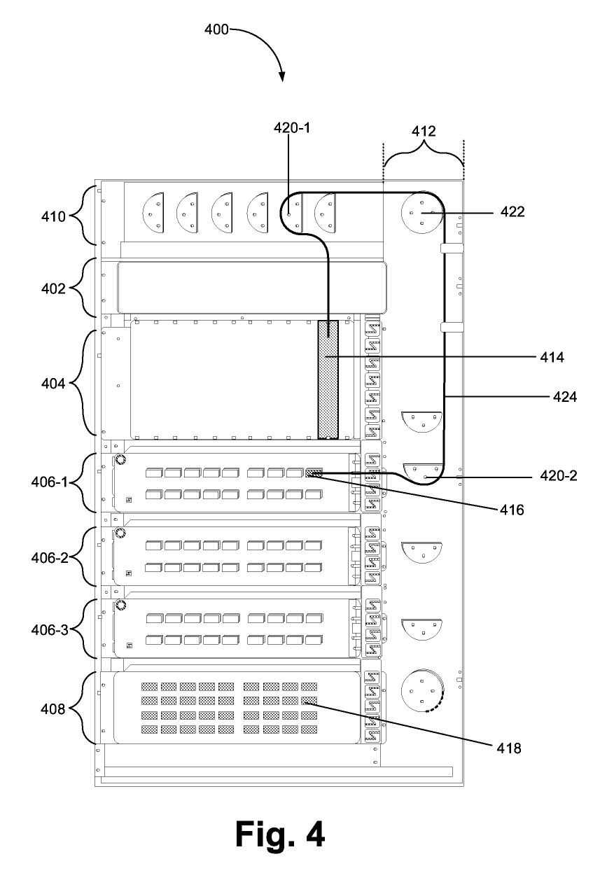

FIG. 4 illustrates fiber distribution hub 206 according to one exemplary implementation 400. As shown, fiber distribution hub 400 may include feeder/input cable space 402, splitter module slots 404, adaptor panels 406-1 through 406-3 (herein collectively and individually referred to as adaptor panels 406 and adaptor panel 406-x, respectively), a parking panel 408, upper slack space 410, and side slack space 412. Depending on the implementation, fiber distribution hub 400 may include fewer, additional, or different components than those illustrated in FIG. 4. For example, in one implementation, fiber distribution hub 400 may not include parking panel 408.

Feeder/input cable space 402 may include space in which feeder optical fiber cables that are routed from the bottom of fiber distribution hub 400 may be spliced or connected to input cables for splitter modules that are inserted in fiber distribution hub 400. In some implementations, splitter modules in fiber distribution hub 400 may be positioned with their input cables facing the back of hub 400, and, feeder input cable space 402 may be eliminated or provisioned toward the back of hub 400.

Splitter module slots 404 may include slots or space into/from which optical splitter modules may be inserted/removed. Depending on the implementation, splitter module slots 404 may accept a splitter module that splits an input beam into 8, 16, 32, or 64 output beams (e.g., 1×8 splitter module, 1×16 splitter module, 1×32 splitter module, 1×64 splitter module, etc.),

In one implementation, splitter module slots 404 may be dimensioned to accept splitter modules which do not include a feature that is herein referred to as fiber loop slack, as described below. In other implementations, splitter module slots 404 may accept splitter modules with fiber loop slack.

Although FIG. 4 shows splitter module slots 404 that are designed to receive splitter modules, such as splitter module 414, in the upright position, in a different implementation, splitter module slots 404 may accept splitter modules 414 in different orientations (e.g., horizontal, sideways, angled, etc.). Depending on the number of living units 216 that are to be connected or served via fiber distribution hub 400, additional splitter modules 414 may be added or removed from splitter module slots 404.

Adaptor panel 406-x may include a panel/matrix of adaptors (e.g., an adaptor array, a plug array, etc.), such as adaptor 416. Adaptor panel 406-x may include a slot into which adaptor 416 may be inserted, such that front and back ports (not shown) of adaptor 416 face the front and the back of fiber distribution hub 400, respectively. In such a configuration, the front port of adaptor 416 may receive a connector that is attached to an output cable from a splitter module (e.g., splitter module 414, and the back port of adaptor 416 may receive a connector that is attached to a distribution cable (e.g., 12-fiber distribution cable), respectively. In a different implementation, adaptor panel 406-x may include adaptor slots. The slots may be filled with adaptors based on need.

In FIG. 4, fiber distribution hub 400 is shown as including three adaptor panels 406, where each adaptor panel has N×M (e.g., 2×9) adaptors/adaptor slots. Depending on the implementation, fiber distribution hub 400 may include additional or fewer adaptor panels 406 (some with different number of adaptors/slots) that may be added or removed based on need.

Parking panel 408 may include slots, ports, or holes into which connectors that are attached to output cables from splitter modules may be temporarily placed. For instance, assume that adaptor 416 in adaptor panel 406-1 is about to be cleaned. In such an instance, a connector that is plugged into adaptor 416 may be unplugged from adaptor 416 and parked in a slot/hole 418 in parking panel 408. After adaptor 416 is cleaned, the connector may be plugged back into adaptor 416.

Upper slack space 410 and side slack space 412 may include space for routing output cables from splitter modules to adaptors in adaptor panel 406-x and/or slots/holes in parking panel 408. As further shown in FIG. 4, upper slack space 410 and side slack space 412 may include cable hooks 420-1 and 420-2, cable disk 422, and other cable hooks and disks (not labeled). Cable hooks 420-1 and 420-2 and cable disk 422 may be used to guide the output cables toward adaptor panel 406-x or parking panel 408.

For example, in FIG. 4, output cable 424 from splitter module 414 may be wound about cable hook 420-1, routed to cable disk 422, bent around cable disk 422 downwardly toward cable hook 420-2, routed to cable hook 420-2, bent around cable hook 420-2, and routed to adaptor 416. Each of cable hooks 420 and cable disks 422 has a radius of curvature that is sufficiently large for an optical fiber cable to bend around the cable hook/disk without damaging optical fibers in the cable or degrading optical signaling.

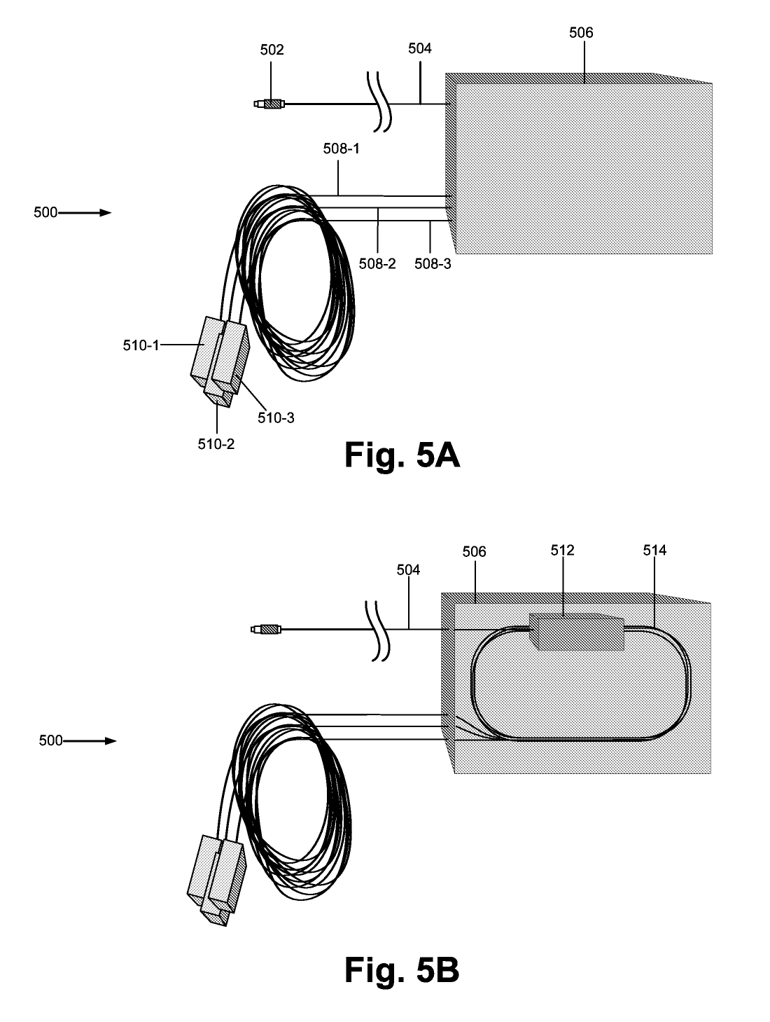

FIG. 5A illustrates an exemplary implementation 500 of splitter module 414. Splitter module 500 includes a feature that is herein referred to as fiber loop slack, as explained further below. As shown, splitter module 500 may include a connector 502, an input cable 504, a splitter container 506, ribbon cables 508-1 through 508-3 (herein collectively referred to as ribbon cables 508 and individually as ribbon cable 508-x), and connectors 510-1 through 510-3 (herein collectively referred to as connectors 510 and individually as connector 510-x). Depending on the implementation, splitter module 500 may include additional, fewer, or different components (e.g., additional ribbon cables 508, connectors 510, etc.) than those illustrated in FIG. 5A.

Connector 502 may include a component that encases an optical fiber end. When connector 502 is coupled to another component (etc., another optical fiber cable, a waveguide, etc.), the fiber end may be axially aligned with the optical signaling path in the other component. Examples of connector 502 may include a subscriber connector (SC), 2 or 3 millimeter (mm) SC-angle polished connector (SC-APC), etc. In some implementations, such as in APC connectors, a ferrule (e.g., a ceramic holder for the optical fiber end) and the fiber end are polished at an angle to reduce internal reflection of the optical signal where the optical fiber is coupled to the other component.

Input cable 504 may encase an optical fiber segment that extends from connector 502 to an optical splitter housed in splitter container 506. In some implementations, input cable 504 may have a fiber that has a functional bend radius of less than or equal to 10 mm. Splitter container 506 may contain splitter components that split an optical signal from input cable 504 into multiple optical signals and output the multiple optical signals via ribbon cables 508.

Ribbon cable 508 may encase one or more optical fiber segments that extend from the optical splitter housed in splitter container 506 to connectors 510. Each ribbon cable 508 may encase multiple optical fiber segments. For example, in one implementation, ribbon cables 508-1, 508-2, and 508-3 may encase 12, 12, and 8 optical fibers, respectively.

Connector 510 may include a component to encase fiber ends. When connector 510 is coupled to another component (e.g., ribbon cable), the fiber ends may be axially aligned with the optical signaling paths in the other component. Examples of connector 510 may include a mechanical transfer-APC (MT-APC), which may have 1.2 times the form factor (e.g., size) of an SC-APC. Such a connector may be mated to another connector attached to a distribution cable running to one of the floors in multiple dwelling unit complex 104. Depending on the number of cable drops per floor, connector 510 may be implemented as 4-fiber, 8-fiber, 12-fiber, or other types of MT-APC connector. The 4-fiber, 8-fiber, or 12-fiber MT-APC may allow, respectively, 4, 8, and 12 cables to be dropped on a floor in a single distribution cable run.

When included in fiber distribution hub 400, splitter modules (e.g., 1×32 splitter modules) that use MT-APCs (e.g., two 12-fiber MT-APCs and one 8-fiber MT-APC) to couple their output cables to distribution cables may allow fiber distribution hub 400 to provide approximately 20 times the number of connections to living units 216 (e.g., via distribution cables and drop cables) than a similarly sized fiber distribution hub that includes splitter modules (e.g., 1×32 splitter modules) using SC-APCs to couple their output cables to distribution cables. For example, fiber distribution hub 400 that includes 18 1×32 splitter modules with two 12-fiber MT-APCs, and an 8-fiber MT-APC (e.g., to accommodate 32 optical fibers) may provide for 576 connections/drop cables.

FIG. 5B is a diagram that illustrates exemplary contents of splitter container 506. As shown, splitter container 506 may include an optical splitter 512 and fiber loop slack 514. In an actual implementation, splitter container 506 may include additional or different components than those illustrated in FIG. 5B.

Optical splitter 512 may include a component to receive input cable 504 and provide optical signals to ribbon cables 508. For example, optical splitter 512 may split an optical signal received via input cable 504 into multiple optical signals and output the multiple optical signals via ribbon cables 508. Optical splitter 512 may be small compared to the overall size of splitter container 506, whose size may be governed by the size of fiber loop slack 514.

Fiber loop slack 514 may include a portion of input cable 504 that is wound into one or more loops before input cable 504 enters optical splitter 512. In addition, fiber loop slack 514 may include a portion of ribbon cables 508 that are wound into one or more loops before output cables 508 exit splitter container 506. The size of fiber loop slack 514 may depend on the type of optical fibers in input cable 504 and output cables 508.

Typically, splitter container 506 may include fiber loop slack 514 for a number of reasons. For example, if optical splitter 512 is located close to an optical signal source (e.g., laser), in terms of relative distance that the optical signal travels from the source to optical splitter 512, the optical signal at optical splitter 512 may be distorted. Including fiber loop slack 514 may increase the distance between the source and optical splitter 512, and therefore, may reduce or eliminate the distortion.

In another example, if optical splitter 512 is located in an outdoor fiber distribution hub, optical splitter 512 may be exposed to climate changes. At low or high temperatures, input cable 504 and/or ribbon cable 508 may contract/expand relative to the encased optical fiber(s). In such instances, without fiber loop slack 514, the encased optical fibers may bend at various points on input and output cables 504 and 508.

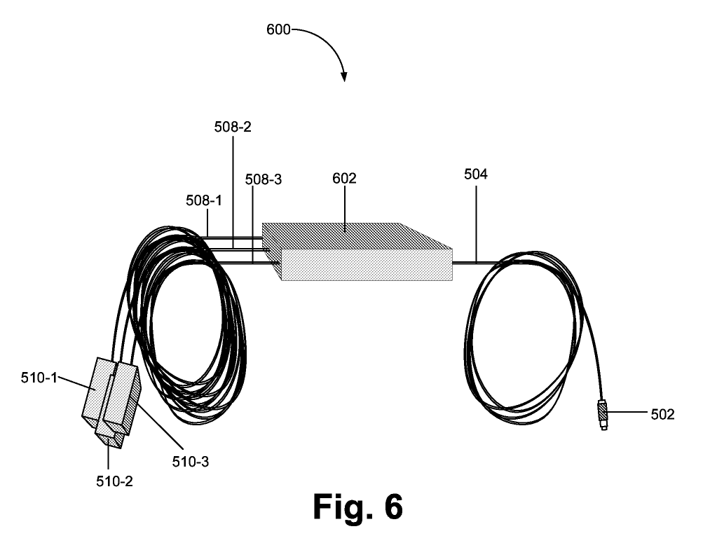

FIG. 6 is a diagram of splitter module 414 according to another implementation 600. Unlike splitter module 500, splitter module 600 may not include fiber loop slack. As shown, splitter module 600 may include components that correspond to some of the components illustrated in FIG. 5A. In FIG. 6, components that correspond to those in FIG. 5A are labeled with the same numbers. The components illustrated in FIG. 6 may operate similarly as the corresponding components described with respect to FIG. 5A.

In contrast to splitter module 500 in FIG. 5A, however, splitter module 600 may include splitter container 602 that is smaller than splitter container 506, as splitter container 602 does not include fiber loop slack, such as fiber loop slack 514. In further contrast, input cable 504 and ribbon cables 508 in splitter module 600 may be located on the back and front sides of splitter container 602, and therefore, when splitter container 602 is inserted inside fiber distribution hub 400, splitter input and outputs may be accessible from the front and back of fiber distribution hub 400.

In some implementations, splitter module 600 may include components that protect the optical splitter within splitter container 602 against forces that may be applied to input cable 504/ribbon cables 508, such as strain relief guides, fan-outs, etc. Without the components, such forces may detach the optical splitter from optical fibers in input cable 504/ribbon cables 508.

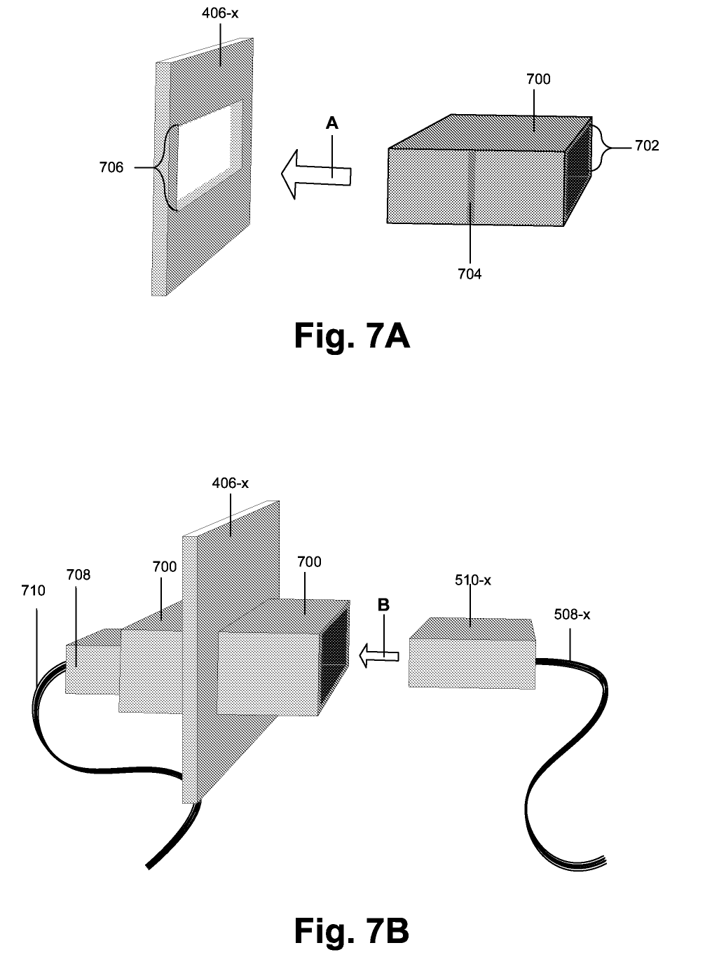

FIG. 7A is a diagram of adaptor 416 according to an exemplary implementation 700. As shown, adaptor 700 may include a front port 702, a back port (not shown), and a fitting feature 704.

Front port 702 may provide a slot into which connector 510-x may be inserted. The back port may provide another slot into which a connector that is attached to a distribution cable may be inserted. In FIG. 7A, the back port is not visible due to the orientation in which adaptor 416 is illustrated. Fitting feature 704 may include an element (e.g., a groove, a protrusion, etc.) that may aid in fitting adaptor 416 in a slot 706 placed in adaptor panel 406-x (see also FIG. 4). In FIG. 7A, adaptor 700 may be slid, in the direction indicated by arrow A, into slot 706 and held in place via fitting feature 704 and slot 706.

FIG. 7B illustrates operation of adaptor 700 after adaptor 700 is fitted into slot 706 of adaptor panel 406-x. As shown, a connector 708 that is attached to a distribution cable 710 is inserted in the back port of adaptor 700. Connector 510-x may optically couple to connector 708 when connector 510-x is inserted in front port 702 in the direction indicated by arrow B. In this manner, adaptor 700 may provide for an optical path from ribbon cable 508-x to distribution cable 710.

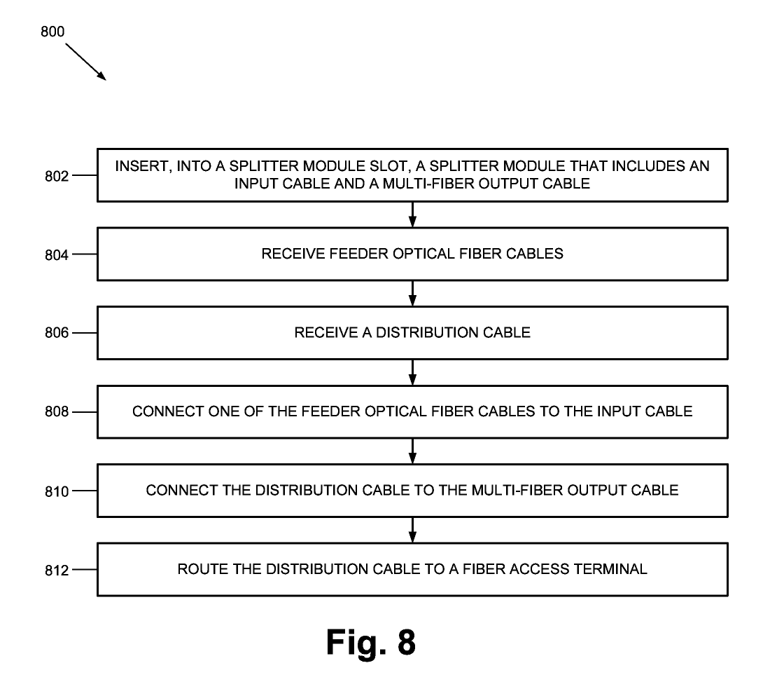

FIG. 8 is a flow diagram of an exemplary process 800 that is associated with operation of fiber distribution hub 400. Although process 800 is depicted as starting at block 802, in different implementations, process 800 may start at other blocks (e.g., block 804, 808, 812, etc.).

Splitter module 414 that includes an input cable and a multi-fiber output cable may be inserted into one of splitter module slots 404 of fiber distribution hub 400 (block 802). Depending on the implementation, the splitter module may include splitter module 500 or 600.

Fiber distribution hub 400 may receive feeder optical fiber cables 108 (block 804). For example, in one implementation, feeder optical fiber cables 108 may be inserted into fiber distribution hub 400 and routed through fiber distribution hub 400 toward splitter module slots 404.

Fiber distribution hub 400 may receive a distribution cable (block 806). For example, the distribution cable may be inserted into fiber distribution hub 400 and routed to the back of adaptor panel 406-x.

One of feeder optical fiber cables 108 may be connected to the input cable of splitter module 414 (block 808). For example, in one implementation, one of feeder optical fiber cables 108 may be connected to input cable 504. More specifically, a connector (e.g., SC-APC connector) attached to one of feeder optical fiber cables 108 may be mated to connector 502 (e.g., SC-APC connector) that is attached to input cable 504 of splitter module 600, via adaptor 416 (e.g., bulkhead adaptor).

The multi-fiber output cable of splitter module 414 may be connected to the distribution cable (block 810). For example, in one implementation, ribbon cable 508-x may be connected to the distribution cable. More specifically, a connector (e.g., MT-APC connector) attached to ribbon cable 508-x may be mated to another connector (e.g., MT-APC connector) that is attached to the distribution cable, via adaptor 416 (e.g., MT-APC plug).

In a building that includes fiber distribution hub 400, the distribution cable may be routed to fiber distribution/access terminal 214 (block 812). Once the distribution cable is run to fiber distribution/access terminal 214, drop cables may be installed from fiber distribution/access terminal 214 to individual livings units to provide optical fiber services from central office 102.

The above describes process 800 associated with various implementations of fiber distribution hub 400 and components that are associated with fiber distribution hub 400. As indicated in the preceding description, fiber distribution hub 400 may be attached to multi-fiber distribution cables. In such cases, a single run of multi-fiber distribution cable may service a number of premises (e.g., living units). For example, a single run of 12-fiber distribution cable may provide for 12 drop cables to 12 different premises. In contrast, where a fiber distribution hub is attached to single-fiber distribution cables, multiple runs of a single-fiber distribution cable may be required to service the same number of premises. Thus, fiber distribution hub 400 may provide for savings in cost associated with deployment (e.g., 30% savings).

Further, in one implementation, fiber distribution hub 400 may include splitter modules 600 that exclude fiber loop slack. By using such splitter modules, fiber distribution hub 400 may be constructed smaller than ones that include splitter modules with single-fiber output cables and/or fiber loop slack (e.g., 60% smaller).

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described with regard to the process illustrated in FIG. 8, the order of the blocks may be modified in other implementations. In addition, non-dependent blocks may represent blocks that can be performed in parallel.

No element, block, or instruction used in the present application should be construed as critical or essential to the implementations described herein unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A device comprising:
a first opening via which a feeder optical fiber cable that carries an input signal enters the device;
a slot configured to retain a splitter module, the splitter module including:
a single-fiber input cable that receives and carries the input signal from the feeder optical fiber cable,
an optical splitter that receives the input signal from the single-fiber input cable, splits the input signal into a plurality of output signals, and transmits each of the plurality of output signals, and
a multi-fiber output cable that receives the plurality of output signals from the optical splitter and carries the plurality of output signals; and
a second opening via which a multi-fiber distribution cable that receives the plurality of output signals from the multi-fiber output cable exits the device, the multi-fiber distribution cable carrying the plurality of output signals.

2. The device of claim 1, further comprising:
an adaptor that mates the multi-fiber output cable to the multi-fiber distribution cable to form optical pathways from the multi-fiber output cable to the multi-fiber distribution cable.

3. The device of claim 2, further comprising:
one or more panels that include adaptor matrices, one panel of the one or more panels including an adaptor matrix that includes the adaptor.

4. The device of claim 3, wherein the one or more panels comprises three panels, and wherein at least one of the three panels includes 18 or fewer adaptor slots.

5. The device of claim 2, further comprising:
components that guide the multi-fiber output cable from the optical splitter to the adaptor without bends that will damage one or more optical fibers in the multi-fiber output cable or degrade optical signals in the multi-fiber output cable.

6. The device of claim 2, wherein the adaptor includes one of:
a plug adaptor array; or
a single plug adaptor.

7. The device of claim 1, further comprising:
a first mechanical transfer-angle polished connector that is attached to an end of the multi-fiber output cable;
a second mechanical transfer-angle polished connector that is attached to an end of the multi-fiber distribution cable; and
an adaptor that couples the first mechanical transfer-angle polished connector to the second mechanical transfer-angle polished connector to form optical pathways from the multi-fiber output cable to the multi-fiber distribution cable.

8. The device of claim 7, wherein the first mechanical transfer-angle polished connector includes one of a 4, 8, 12, 16, 20, 24, 28, 32, or 36-fiber mechanical transfer-angle polished connector.

9. The device of claim 7, further comprising:
a first subscriber connector-angle polished connector that is attached an end of the feeder optical fiber cable;
a second subscriber connector-angle polished connector that is attached to an end of the single-fiber input cable; and
an adaptor that couples the first subscriber connector-angle polished connector to the second subscriber connector-angle polished connector to provide an optical pathway from the feeder optical fiber cable to the single-fiber input cable.

10. The device of claim 7, further comprising:
a panel for parking the first mechanical transfer-angle polished connector.

11. The device of claim 1, wherein the splitter module includes one of:
a splitter module that includes fiber loop slack;
a splitter module that does not include fiber loop slack; or
a splitter module that is removable from the slot and the device.

12. The device of claim 1, further comprising:
an area, located at a top or side of the device, that retains a connection between the feeder optical fiber cable and the single-fiber input cable.

13. The device of claim 1, wherein the multi-fiber distribution cable includes optical fibers that are routed within a multiple dwelling unit to a fiber access terminal.

14. The device of claim 1, wherein the multi-fiber output cable includes a ribbon cable.

15. The device of claim 1, wherein the device includes a Underwriter Laboratory (UL) listed enclosure.

16. A method comprising:
routing, into a device, a feeder optical fiber cable that carries an input signal;
routing, into the device, a multi-fiber distribution cable that is to carry a plurality of output signals;
inserting a splitter module into a slot in the device, the splitter module including:
a single-fiber input cable to receive the input signal;
an optical splitter to receive the input signal from the single-fiber input cable, split the input signal from the single-fiber input cable into a plurality of output signals, and transmit the plurality of output signals, and
a multi-fiber output cable that receives the plurality of output signals from the optical splitter;
connecting the feeder optical fiber cable to the single-fiber input cable; and
connecting the multi-fiber output cable to the multi-fiber distribution cable.

17. The method of claim 16, wherein connecting the multi-fiber output cable to the multi-fiber distribution cable includes:
mating, via an adaptor plug, a first mechanical transfer-angle polished connector (MT-APC) attached to an end of the multi-fiber output cable and a second mechanical transfer-angle polished connector (MT-APC) attached to an end of the multi-fiber distribution cable.

18. The method of claim 17, further comprising:
routing the multi-fiber output cable to a fiber distribution terminal; and
routing a drop cable from the fiber distribution terminal to a living unit.

19. The method of claim 16, wherein connecting the feeder optical fiber cable to the single-fiber input cable includes:
mating, via a bulkhead adaptor, a first subscriber connector-angle polished connector (SC-APC) that is attached to an end of the feeder optical fiber cable and a second subscriber connector-angle polished connector (SC-APC) attached to an end of the single-fiber input cable.

20. A device comprising:
an enclosure, the enclosure including:
a feeder optical fiber cable that carries an input signal;
a splitter module configured to:
receive the input signal from the feeder optical fiber cable,
split the input signal into a plurality of output signals, and
transmit each of the plurality of output signals via a multi-fiber ribbon cable; and
a multi-fiber distribution cable mated with the multi-fiber ribbon cable, the multi-fiber distribution cable relaying the plurality of output signals to a fiber access terminal.
